(19) United States
(12) Patent Application Publication
(10) Pub. No.: US 2005/0108534 A1
(43) Pub. Date: May 19, 2005

(54) Providing services to an open platform implementing subscriber identity module (SIM) capabilities

(76) Inventors: Sundeep M. Bajikar, Santa Clara, CA (US); Luke E. Girard, Santa Clara, CA (US); Ramgopal K. Reddy, Portland, OR (US); Francis X. McKeen, Portland, OR (US); Kelan C. Silvester, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/718,369

(22) Filed: Nov. 19, 2003

(51) Int. Cl. H04L 9/00

(52) U.S. Cl. 713/172; 713/201

(57) ABSTRACT

An approach for providing services to an open platform implementing Subscriber Identity Module (SIM) capabilities without the need for a discrete, physical SIM device. For one aspect, a protected communications channel is established with a computing system, the computing system providing SIM Authentication, Authorization and Accounting (AAA) capabilities without the use of a discrete hardware SIM device. SIM secret data is provisioned to the computing system over the protected communications channel.

### CROSS-REFERENCE TO RELATED APPLICATION

This application is related to co-pending U.S. patent application Ser. No. ______ entitled, “A METHOD AND APPARATUS FOR IMPLEMENTING SUBSCRIBER IDENTITY MODULE (SIM) CAPABILITIES IN AN OPEN PLATFORM,” Attorney Docket Number 42P17642, assigned to the assignee of the present invention.

### BACKGROUND

An embodiment of the present invention relates to the field of computing systems and, more particularly, to providing services to an open platform implementing Subscriber Identity Module (SIM) and/or related capabilities.

Currently, a hardware SIM device may be used, for example, to provide user authentication to a GSM/GPRS (Global System for Mobile communications/General Packet Radio Services) network for authorization and accounting purposes. The overall purpose of the SIM device is referred to as Authentication, Authorization and Accounting (AAA).

A hardware SIM device as described in the European Telecommunications Standards Institute (ETSI) GSM 11.11 specification, Version 5.0.0, December 1995, for example, provides the following capabilities within the SIM hardware, which is regarded as a trusted environment: 1) protected execution for the A3 algorithm (an authentication algorithm), 2) protected execution for the A8 algorithm (a cipher key generator algorithm that generates a ciphering or cryptographic key Kc and 3) protected storage for SIM secret data objects.

Examples of protocols that may be used in conjunction with a SIM are Extensible Authentication Protocol (EAP) and Authentication and Key Agreement protocol (AKA). Protected storage of SIM data objects contained within the physical storage medium of the SIM is typically accomplished by encrypting the secrets using a suitable method of encryption and then locking the encryption key using a cryptographic device such as a Trusted Platform Module (TPM) or other hardware token. Remaining SIM capabilities are considered to be secure because SIMs operate in a closed environment, such that there is not an interface available to program to.

In addition to the above-described capabilities, the following capabilities may be provided in a trusted environment external to the discrete SIM hardware device: 1) protected provisioning for a subscriber identification key Ki, 2) protected provisioning for the A5 algorithm (a cipher algorithm) in the Mobile Equipment (ME) and 3) protected provisioning for security policies.

### BRIEF DESCRIPTION OF THE DRAWINGS

The present invention is illustrated by way of example and not limitation in the figures of the accompanying drawings in which like references indicate similar elements, and in which:

FIG. 1 is a high-level block diagram of a computing system via which the SIM capabilities of various embodiments may be implemented.

FIG. 2 is a high-level block diagram of a computing system and associated software that may be used for various embodiments.

FIG. 3 is a high-level block diagram showing protected and open partitions and paths that may be provided for one embodiment.

FIG. 4 is a flow diagram showing a method of one embodiment for provisioning SIM data, algorithms, etc.

FIG. 5 is a flow diagram showing a method of one embodiment for storing SIM secret data on an open platform in a protected manner.

FIG. 6 is a flow diagram showing a method of one embodiment for accessing SIM secret data.

### DETAILED DESCRIPTION

A method and apparatus for implementing Subscriber Identity Module (SIM) capabilities is described. In the following description, particular components, software modules, systems, etc. are described for purposes of illustration. It will be appreciated, however, that other embodiments are applicable to other types of components, software modules and/or systems, for example.

References to “one embodiment,” “an embodiment,” “example embodiment,” “various embodiments,” etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

While SIMs are currently most commonly used in wireless telephones, the authentication, authorization and accounting (AAA) features of SIM devices may also be useful in other environments and/or for other types of applications. For example, security is an increasingly important issue for personal and other computing platforms. In particular, with the growth of the Internet, wireless communications and connected Mobile computing, personal computers, including notebook computers, are more frequently being used for e-commerce and other applications where data security is of paramount importance. Thus, there is a growing need to increase the trustworthiness of computer systems.

For one embodiment, one or more SIM and/or Universal SIM (USIM) capabilities are implemented in a trusted environment in an open platform, such as a personal computing platform. For example, a personal computing (PC) platform including protected (or trusted) and open (or untrusted) partitions and/or paths may be re-partitioned to provide one or more capabilities associated with a discrete SIM hardware device, without the need to include a discrete SIM hardware device. In this manner, GSM/GPRS (Global System for Mobile communications/General Packet Radio Services) or other types of wireless and/or wired communications to and from the computing platform and/or between applications and resources or services may be enabled without an on-board, discrete SIM hardware device.

Such SIM capabilities may include, for example, protected storage for SIM secrets on an open platform using protected execution of an encryption algorithm and protected transport and storage of encryption keys. Further, in accordance with various embodiments, SIM data may be provisioned to an open platform that executes a first trusted code module in a protected environment and communicates with a second code module that executes in a trusted execution environment on a provisioning server. A SIM application programming interface (API) that is used by trusted applications to access SIM capabilities such as key generation, access to secrets, etc. may also be provided for some embodiments. The SIM capabilities of various embodiments may be used for a variety of applications including providing AAA capabilities for subscriber accounts, for example, that may be accessed by a computing system. Further details of these and other embodiments are provided in the description that follows.

Embodiments of the invention may be implemented in one or a combination of hardware, firmware, and software. Embodiments of the invention may also be implemented in whole or in part as instructions stored on a machine-readable medium, which may be read and executed by at least one processor to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

In the description that follows, the terms protected or trusted areas or paths may refer to areas of a device or paths between devices that have sufficient protections associated with them to prevent access to them by unauthorized devices and/or software. Further, the terms trusted software or code may refer to software that has been validated through some means to verify that it has not been altered in an unauthorized manner before execution.

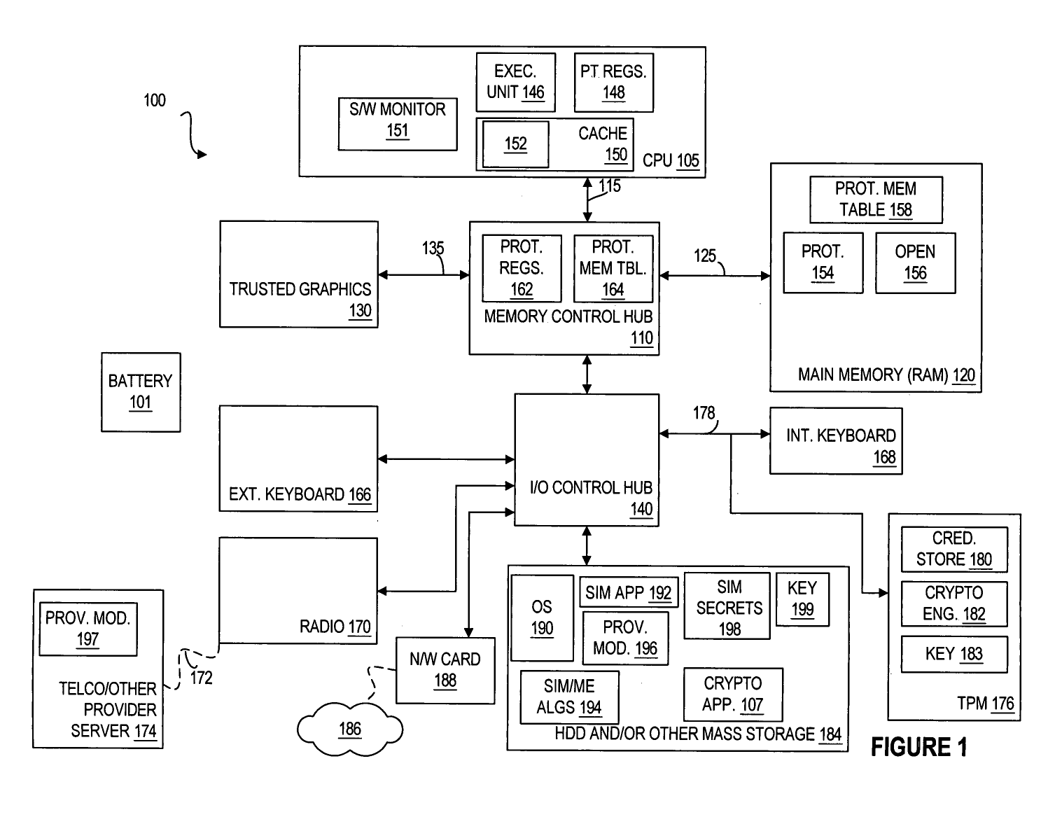

FIG. 1 is a block diagram of a computing system 100 that may advantageously implement one or more SIM capabilities according to one embodiment without the use of a discrete hardware SIM device. The computing system 100 may for example be a mobile computing system such as a notebook or laptop computer. Alternatively, the computing system 100 may be a different type of computing system such as a desktop computer, a workstation computer, a personal digital assistant, or another type of computing device. Where the computing system 100 is a mobile computing system, a battery and/or battery connector 101 may be included and coupled to the system 100 in a conventional manner to provide an alternate power source for the computing system 100 when, for example, an alternating current power source is not available or convenient.

The computing system 100 includes a central processing unit (CPU or processor) 105 coupled to a memory control hub (MCH) or other memory controller 110 via a processor bus 115, a main memory 120, which may comprise, for example, random access memory (RAM) or another type of memory, coupled to the MCH 110 over a memory bus 125, one or more trusted graphics components 130 coupled to the MCH 110 over a graphics bus 135 or integrated with another component in the system 100, and an input/output (I/O) control hub (ICH) or other I/O controller 140, which may be coupled to the MCH 110 over a bus 145. The memory controller (or MCH) 110 and the I/O controller (or ICH) 140 may be referred to collectively as the chipset.

The chipset may be a logic circuit to provide an interface between the processor 105, the memory 120, and other devices. For one embodiment, the chipset is implemented as one or more individual integrated circuits as shown in FIG. 1, but for other embodiments, the chipset may be implemented as a portion of a larger integrated circuit or it may be implemented as parts of multiple other integrated circuits. Although individually labeled herein as a memory controller and I/O controller, these labels should not be read as a limitation on how the chipset features may be physically implemented.

The processor 105 of one embodiment may be an Intel architecture microprocessor that implements a technology, such as Intel Corporation's LaGrande technology (also referred to herein as LT), that provides for protected execution along with other security-oriented features. Some details of LaGrande technology may currently be found, for example, at http://www.extremetech.com/article2/0,3973,1274197,00.asp. For other embodiments, the CPU 105 may be another type of processor such as, for example, an embedded processor, a digital signal processor, a microprocessor from a different source, having a different architecture or a different security technology, etc. and/or more than one processor may be included. The processor 105 may include an execution unit 146, page table (PT) registers 148, one or more on-chip and/or off-chip cache memories 150 and a software monitor 151.

All or part of the cache memory 150 may include, or be convertible to, protected memory 152. Protected memory, as described above, is a memory with sufficient protections to prevent access to it by an unauthorized device (e.g., any device other than the associated processor 105) while activated as a protected memory. In the illustrated embodiment, the cache memory 150 may have various features to permit its selective isolation as a protected memory. The protected memory 152 may alternatively or additionally be external to and separate from the cache memory 150 for some embodiments, but still associated with the processor 105.

PT registers 148 may be used to implement a table to identify which memory pages are to be accessible only by trusted code and which memory pages are not to be so protected.

The trusted software (S/W) monitor 151 may monitor and control the overall protected operating environment once the protected operating environment has been established. The software monitor may alternatively be provided on the memory controller 110 or elsewhere in the system 100. In a particular embodiment, the trusted S/W monitor 151 may be located in a protected memory such as the memory 152 such that it is itself protected from unauthorized alterations.

The processor 105 may further be capable of executing instructions that provide for protected execution of trusted software. For example, the execution unit 146 may be capable of executing instructions to isolate open and protected partitions in on-chip (e.g. the cache memory 150) and off-chip memory (e.g. the main memory 120) and to control software access to protected memory.

The MCH 110 of one embodiment may provide for additional memory protection to block device accesses (e.g. DMA accesses)) to protected memory pages. For some embodiments, this additional memory protection may operate in parallel to the execution of the above-described instruction(s) by the CPU 105 to control software access to both on and off-chip protected memory to mitigate software attacks.

For example, the MCH 110 may include protected registers 162, and a protected memory table 164. In one embodiment, the protected registers 162 are registers that are writable only by commands that may only be initiated by trusted microcode (not shown) in the processor 105. Protected microcode is microcode whose execution may only be initiated by authorized instruction(s) and/or by hardware that is not controllable by unauthorized devices.

The protected registers 162 may hold data that identifies the locations of, and/or controls access to, the protected memory table 164 and the trusted S/W monitor 151. The protected registers 162 may include a register to enable or disable the use of the protected memory table 164 so that DMA protections may be activated before entering a protected operating environment and deactivated after leaving the protected operating environment, for example. Protected registers 162 may also include a writable register to identify the location of the protected memory table 164, so that the location does not have to be hardwired into the chipset.

For one embodiment, the protected registers 162 may further store the temporary location of the trusted S/W monitor 151 before it is placed into protected locations of the memory 120, so that it may be located for transfer when the protected operating environment provided by the system 100 is initialized. For one embodiment, the protected registers 162 may include an execution start address of the trusted S/W monitor 151 after the transfer into memory 120, so that execution may be transferred to the trusted S/W monitor 151 after initialization of the protected operating environment.

The protected memory table 164 may define the memory blocks (where a memory block is a range of contiguously addressable memory locations) in the memory 120 that are to be inaccessible for direct memory access (DMA) transfers and/or by other untrusted sources. Since all accesses associated with the memory 120 are managed by the MCH 110, the MCH 110 may check the protected memory table 164 before permitting any DMA or other untrusted transfer to take place.

In one embodiment, the protected memory table 164 may be implemented as a table of bits, with each bit corresponding to a particular memory block in the memory 120. In a particular operation, the memory blocks protected from DMA transfers by the protected memory table 164 may be the same memory blocks restricted to protected processing by the PT registers 148 in the processor 105.

The main memory 120 may include both protected 154 and open 156 memory pages or partitions. Access to protected pages or partitions 154 in memory 120 is limited by the CPU 105 and/or the MCH 110 to specific trusted software and/or components as described in more detail herein, while access to open pages or partitions in the memory 120 is according to conventional techniques.

As illustrated in FIG. 1, the main memory 120 may further include a protected memory table 158. In one embodiment, the protected memory table is implemented in the MCH 110 as the protected memory table 164 as described above and the protected memory table 158 may be eliminated. In another embodiment, the protected memory table is implemented as the protected memory table 158 in the memory 120 and the protected memory table 164 may be eliminated. The protected memory table may also be implemented in other ways not shown. Regardless of physical location, the purpose and basic operation of the protected memory table may be substantially as described.

With continuing reference to FIG. 1, where the computing system 100 is a mobile computing system, such as, for example, a laptop or notebook computer, the ICH 140 may be coupled to both an external keyboard 166 and an internal keyboard 168. For other types of systems and/or for some mobile systems, only one of the external and internal keyboards may be provided. A secure or trusted path between the external 166 and/or internal keyboard 168 and trusted software is provided to protect the trusted partition of the system 100 from untrusted inputs or other types of attacks. For one embodiment, this secure path may be in accordance with, for example, copending patent application Ser. No. 10/609,828 entitled, “Trusted Input for Mobile Platforms Transactions,” filed Jun. 30, 2003 and assigned to the assignee of the present invention.

A radio 170, which may be part of a wireless local or wide area network (WLAN or WWAN) or other wireless networking card, may also be coupled to the ICH 140 to provide for wireless connectivity over a wireless network 172, which may be operated/serviced by a telephone company (telco) or other service provider and/or may be used by a service provider to provide services to the computing system 100. For such an example, a server operated by the service provider, such as the server 174, may couple to the computing system 100 over the wireless network 172 via the radio 170. The network 172 may be a GSM/GPRS (Global System for Mobile communications/General Packet Radio Services) network, for example. Other types of wireless network protocols such as, for example, CDMA (Code Division Multiple Access), PHS (Personal Handyphone System), 3G (Third generation services) networks, etc. are also within the scope of various embodiments.

A hardware token such as a Trusted Platform Module (TPM) 176, which may be in accordance with a currently available or future revision of the TPM specification, currently version 1.1, available from the Trusted Computer Platform Alliance (TCPA) and version 1.2 of the Trusted Computing Group (TCG), may also be coupled to the ICH 140 over, for example, a low pin count (LPC) bus 178. The TPM 176 may be provided to protect data related to creating and maintaining a protected operating environment and is associated directly with the computing system 100. In other words, the hardware token 176 is not moved from system to system.

For one embodiment, the hardware token 176 is a discrete hardware device that may be implemented, for example, using an integrated circuit. For another embodiment, the hardware token 176 may be virtualized, i.e. it may not be provided by a physically separate hardware chip on the motherboard, but may instead be integrated into another chip, or the capabilities associated with a TPM or other hardware token as described herein, may be implemented in another manner.

The TPM 176 of one embodiment may include a credential store 180, which may comprise non-volatile memory, to store password and credential information associated with the system 100. The TPM 176 of one embodiment may further include a cryptographic engine 182, digital signatures (not shown), a hardware random number generator (not shown) and/or monotonic counters (not shown).

The TPM 176 has a locked state in which information stored in the credential store 180 is inaccessible or otherwise protected, and an unlocked state in which information stored in the credential store 180 may be accessible by certain software or components. In particular embodiments, the hardware token 176 may include a key 183, which may be an embedded key to be used for specific encryption, decryption and/or validation processes.

A hard disk drive (HDD) and associated storage media and/or other mass storage device 184, such as a compact disc drive and associated media, may also be coupled to the ICH 140. While only one mass storage reference block 184 is shown in FIG. 1, it will be appreciated that multiple mass storage devices of various types may be used to implement the mass storage device 184. Further, additional storage devices may be accessible by the computing system 100 over the network 172 or over another network 186 that may be accessed via a network card, modem or other wired communications device 188, for example.

The computing system 100 may further run an operating system 190 that provides for open and protected partitions for software execution. For one embodiment, the operating system 190 may be provided by Microsoft Corporation of Redmond, Wash., and may incorporate Microsoft's Next-Generation Secure Computing Base (NGSCB) technology. The operating system 190 is shown as being stored on the mass storage device 184, but all or part of the operating system 190 may be stored in another storage device on or accessible by the computing system 100.

The mass storage device 184 may further store one or more SIM-related applications 192 and/or one or more SIM and/or ME algorithms 194.

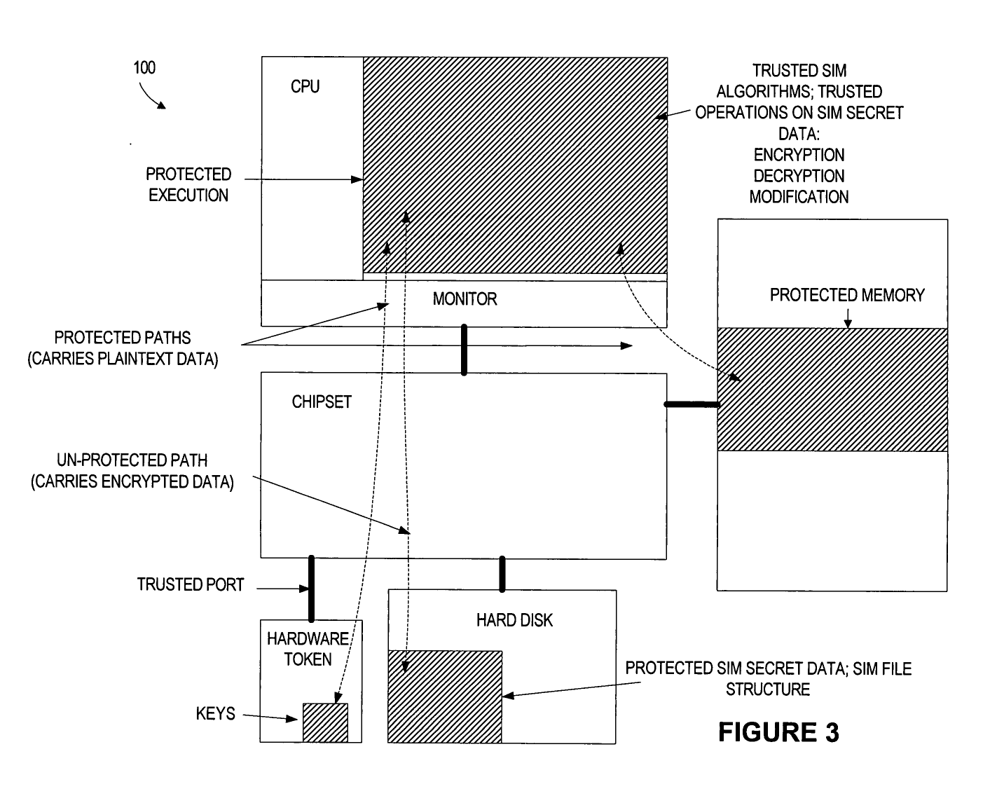

FIG. 3 shows, at a high level, various trusted paths and partitions that may be provided in the computing system 100 of one exemplary embodiment when a trusted execution environment has been established. The trusted areas are shaded in FIG. 3. For other embodiments, it will be appreciated that different trusted paths and partitions may be provided and/or all the trusted paths and partitions shown in FIG. 3 may not necessarily be provided.

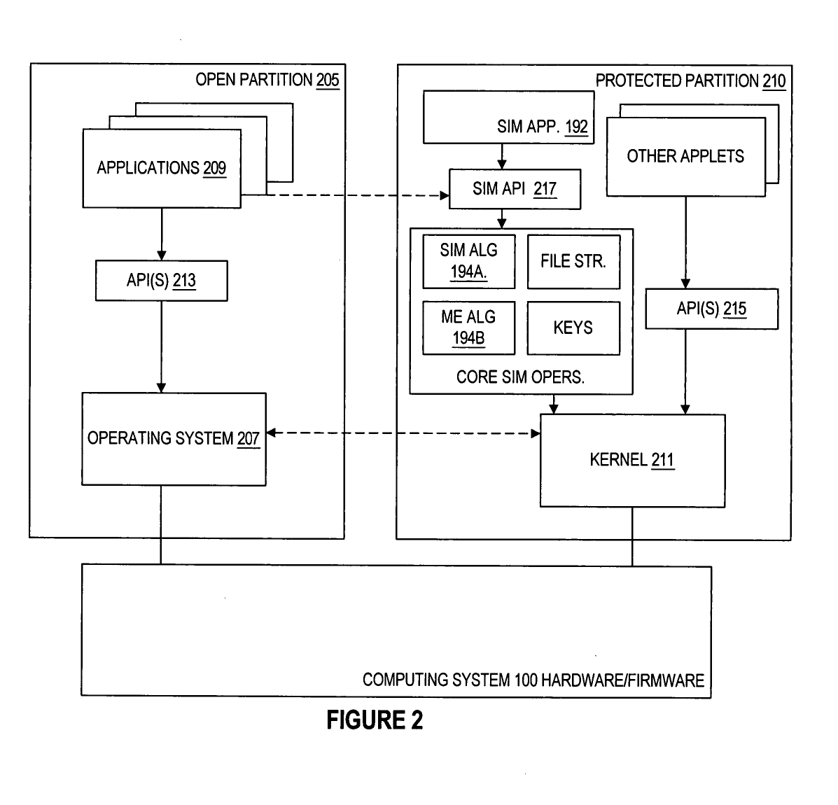

FIG. 2 is a high-level conceptual drawing showing various partitions that may be provided by the operating system 190 of FIG. 1 when a secure operating environment has been established for one embodiment. An open partition 205 provided by the operating system 190 runs the main operating system 207, drivers (not shown), applications 209 and associated APIs 213. A protected partition 210 includes a protected operating system kernel 211 and protected applets or applications such as one or more SIM-related applications 192 that may include or interoperate with SIM and/or Mobile Equipment (ME) algorithms 194A and 194B. Associated API(s) 215 and 217 (described in more detail below) may also be included. Security features such as those described herein may be accessible to software developers through various APIs, for example.

While some elements of a specific platform architecture and a specific, associated operating system are described above, it will be appreciated that other platform architectures and/or operating system architectures that provide for protected storage, protected execution and protected input/output as described herein may also be used for various embodiments.

For one embodiment, as described above, SIM and/or USIM capabilities are provided on an open platform, such as the computing platform 100 of FIG. 1 without a need to provide a discrete hardware SIM device.

SIM capabilities may be useful on an open computing platform for a variety of purposes. For example, SIM capabilities provided by various embodiments may be used to manage access to and/or use of the wireless network 172 (which may be a GSM/GPRS or 3G network or a different type of network) or a service accessible over the wireless network 172 via the radio 170. Services that may be accessible by the computing system 100 and for which it may be advantageous to use the SIM and/or USIM capabilities described herein include, for example, location-based services and/or other value-added features. Alternatively or additionally, SIM capabilities may be used for other types of network-based subscriber accounts that may be accessed and used over the network 186. Even application software 209 or another application may make use of SIM capabilities for authorization, authentication and/or accounting purposes for various networks or for other purposes.

For purposes of example, it is assumed that the SIM capabilities provided for various embodiments are used in conjunction with a subscriber account provided by the telephone company (telco) or other service operator that owns/operates the server 174 accessible via the network 172 and/or the network 172. The service provider may provide the user of the computing system 100 with application software such as the application software 192 and/or SIM and/or ME algorithms 194. Alternatively, the SIM and/or ME algorithms may be provided in another manner.

For one embodiment, the computing system 100 may be provisioned with SIM secrets, data, algorithms and/or applications such as, for example, roaming parameters, service profiles, performance parameters, the subscriber authentication key Ki, an International Mobile Subscriber Identity (IMSI), and/or new or updated SIM algorithms or applications. A provisioning module 196 may be stored on the mass storage device 184 or another storage device or memory accessible by the computing platform 100. The provisioning module 196 may be executed in the trusted environment provided by the computing system 100 in the protected partition 210. A service provider provisioning module 197 may be executed in a trusted environment provided by the service provider server 174.

Provisioning may take place when a subscriber first subscribes to services offered by a network operator or other service provider, or when needed to update parameters, code, etc. related to the services being provided, for example. In either case, provisioning may be initiated by the client computing system 100 or the provisioning server (e.g. the server 174, in this example). Goals of provisioning may include, but not be limited to, one or more of the following: assigning a unique identity to the client to enable subscription services and billing (e.g. for a SIM, the IMSI and Ki secrets related to user identity need to be provisioned), initializing various data objects that may or may not contain secret information associated with the service provider, initializing operator specific cryptography algorithms that are used to carry out AAA functions, and/or installing or updating applications, parameters, tools or utilities, which may be operator-specific, for example.

Provisioning, according to one embodiment, involves the use of one or more protected channels of communication between the client computing system 100 and the provisioning server. Additional trusted channels of communication may be provided to network interfaces for some embodiments to further strengthen the security of the solution.

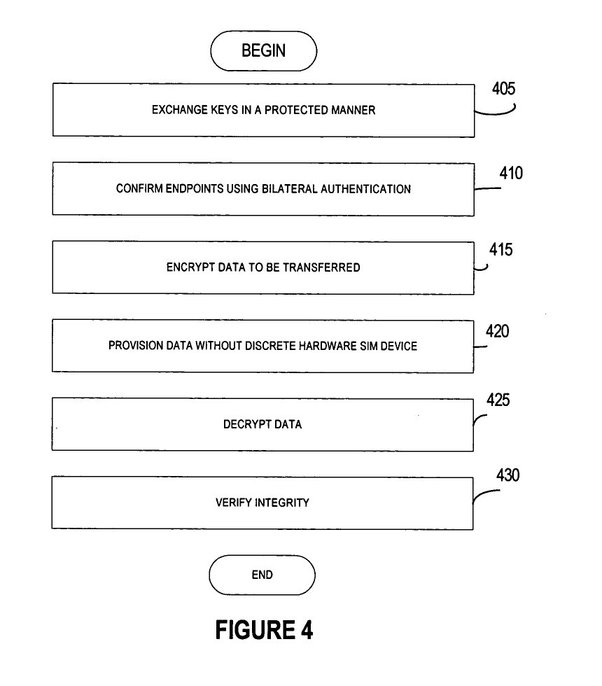

Referring to FIG. 4, establishing a protected channel of communication may include the following: use of a protected key exchange mechanism at block 405, wherein the client key may be generated, for example, using a TPM or other hardware token, use of bilateral authentication to identify and confirm the endpoints at block 410, use of a suitable encryption mechanism to scramble the data being transceived at block 415, wherein the encryption mechanism may be provided by, for example, an encryption/decryption algorithm stored on a hard drive or other storage device, provisioning the data at block 420, decrypting the data at block 425 and use of a suitable integrity checking mechanism at block 430 such as, for example, Message Authentication Code (MAC).

On the client side, establishment of the protected channel(s) of communication between the computing system 100 and the provisioning server 174 is carried out within the protected execution environment provided by the computing system that implements, for example, Intel's LaGrande technology. This may include generation of keys using a hardware token, such as the TPM 176, in a protected manner, running encryption algorithm(s) in the protected execution environment, and/or storing installed SIM secrets on the platform 100 in an encrypted format.

Any available physical channel of communications may be used for provisioning purposes. These may include Local Area Networks (LANs) or Wide Area Networks, such as the network 186, Wireless LANs (WLANs) and Wireless Wide Area Networks (WWANs) such as the network 172, for example. These protected channels may be provided using the processor, chipset and/or other components working together, for example. For flexibility, the TCP/IP protocol may be used for provisioning-related communications, but any other suitable protocol may also be used.

While the flow chart of FIG. 4 depicts actions that may be performed by the provisioning server along with actions that may be performed by a client computing system, it will be appreciated that, for various embodiments, only some of the actions described in conjunction with FIG. 4 may be performed and/or additional actions may be performed.

For example, for one embodiment, only the actions performed by the provisioning server (e.g. participating in establishing exchanging keys, bilateral authentication, and encrypting and transferring data) may be performed. For another embodiment, only the actions associated with the client computing system (e.g. participating in bilateral authentication, receiving encrypted data, decrypting data, etc.) may be performed.

Once provisioned, protected storage may be provided for SIM secret data objects and/or other information when they are not in use. For one embodiment, SIM data objects 198 are stored in an encrypted format on the hard drive 184 or any other storage media or other non-volatile memory. An associated key 199, which may be referred to as a bulk encryption key, may also be encrypted and stored on the mass storage device 184.

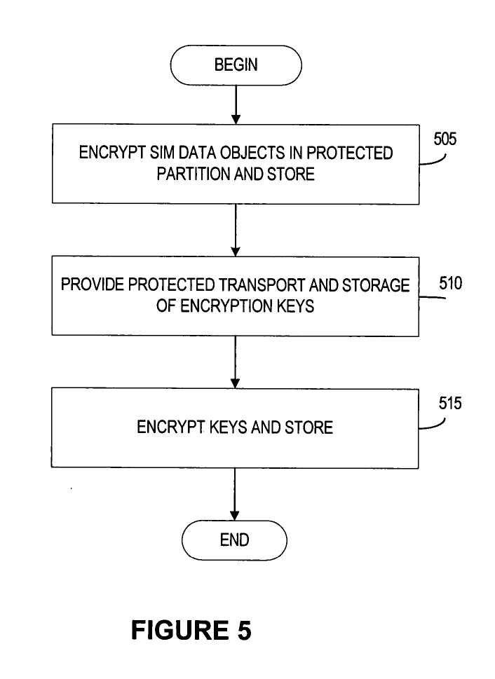

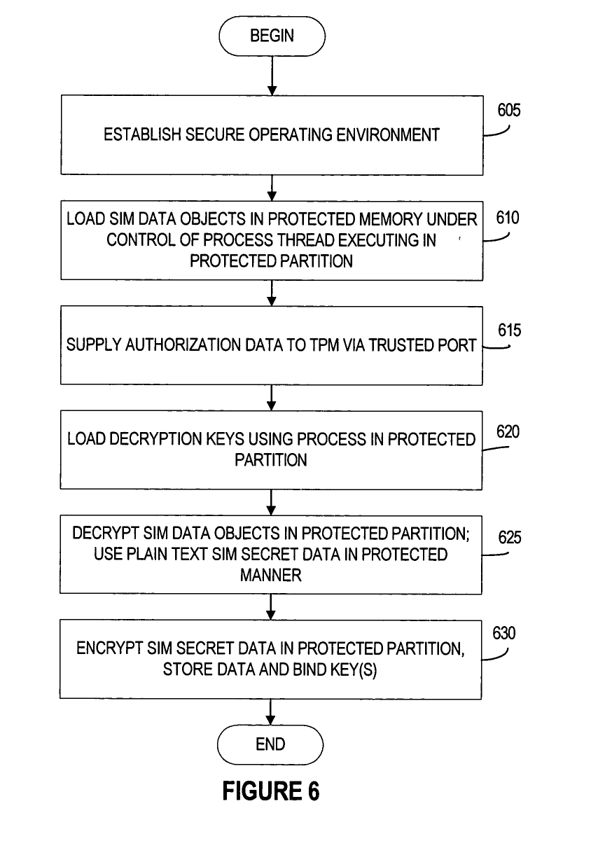

Referring to FIGS. 1, 2 and 5, for one embodiment, the protected execution environment provided by the computing platform 100 as described above is used to execute an encryption algorithm 107 to encrypt the SIM data objects and store them on, for example, the mass storage device 184 at block 505. While FIGS. 1 and 2 are referred to for purposes of example in relationship to the description of the methods illustrated in FIGS. 4, 5 and 6, it will be appreciated that the elements of FIGS. 1 and 2 are not necessarily needed to implement all embodiments.

In conjunction with the encryption algorithm 107, the TPM 176 is used to provide protected transport and storage of encryption keys at block 510. The bulk encryption key(s) used with the encryption algorithm 107 are provided to the TPM, encrypted using the encryption engine 182 such that the key(s) are sealed at block 515, and then stored on the mass storage device 184 as the key 199 at block 520.

Referring to FIGS. 1, 2 and 6, a method of one embodiment for accessing SIM data objects previously stored in a protected manner is described.

At block 605, to access the SIM data objects, the LT environment or other secure operating environment is first loaded and established. The encrypted SIM data objects are then loaded into a protected memory such as the memory 154 under the control of a process thread executing in a protected partition 210 at block 610. Authorization data is supplied to the TPM 176 via a trusted port at block 615 and decryption key(s) 183 are then loaded using the protected storage capabilities of the TPM 176 by a protected process at block 620. The decryption key(s) 183 may then be used to decrypt the encrypted bulk encryption key 199. Additional intermediate actions may be involved for some embodiments as described in more detail the TPM Specification version 1.1 available from the TCPA and/or the TPM Specification version 1.2 available from the TCG.

At block 625, the SIM secret data 198 is decrypted in the protected partition 210 and used in a trusted manner for the intended purpose. This may include erasing or modifying the content of the SIM secret data. When all operations on the SIM secret data have been completed, the data is encrypted in the protected partition 210 in the manner described, the key is bound and the encrypted data 198 and bulk encryption key 199 are stored at block 630 as described above.

Other approaches for storing SIM secret data in a protected manner are within the scope of various embodiments.

The SIM capabilities provided by the computing platform 100 may further include protected execution for A3 (authentication), A8 (cipher key (Kc) generation) and/or A5 (cipher) algorithms and a protected path to provide for protected communications of secrets and/or user voice/data. Definitions and further details of the A3, A8 and A5 algorithms, as well as definitions and further details of the keys Kc and Ki and the IMSI that may be used in conjunction with these algorithms, can be found, for example, in the ETSI GSM 11.11 specification, version 5.3.0, July 1996 (or another version), ETSI GSM 03.20 v/8.1.0 (GSM Encryption Algorithms) and/or in 3GPP (Third Generation Partnership Project) TS 43.020 V5.0.0, 2002-7 (or another version).

Referring to FIGS. 1 and 2, as described above, the mass storage device 184 or another memory may store the SIM application(s) 192 that may be executed by the processor 105. The SIM application 192 may be considered to be a trusted application and may control execution of various algorithms such as SIM and/or ME algorithms 194 as needed to provide SIM capabilities that are typically provided by a discrete hardware SIM device.

In particular, the SIM algorithms 194A may include code to be executed by the processor 105 in a secure mode to provide all or portions of the A3, A8 and/or A5 algorithms referenced in the ETSI GSM 11.11 specification and/or other algorithms or capabilities associated with a SIM or USIM. The A3 algorithm is an authentication algorithm used to authenticate a subscriber. As defined in ETSI GSM 03.20 v/8.1.0 (“GSM 03.20”), the purpose of A3 algorithm is to allow authentication of a subscriber's identity. To this end, the A3 algorithm must compute an expected response SRES from a random challenge RAND sent by a network such as the network 172 or the network 186. For this computation, the A3 algorithm makes use of a secret authentication key Ki.

The A8 algorithm is a cipher key generator algorithm used to generate the cipher key Kc that may be used to encrypt voice and/or data communications. The A8 algorithm may or may not be combined with the A3 algorithm. As defined in GSM 03.20, the A8 algorithm must compute the ciphering key Kc from the random challenge RAND sent during the authentication procedure, using the authentication key Ki.

The A5 algorithm is used to encrypt and decrypt communications from and to the computing system 100 using IMSI and Kc. Each of the A3, A8 and A5 algorithms may be implemented in a variety of different ways depending on the provider of the algorithms.

When the secure operating environment provided by the computing system 100 is initialized, the trusted application 192 is loaded into the protected partition 210. Then, anytime one or more of the A3, A8 and/or A5 algorithms is to be executed to provide user authentication, authorization and accounting (AAA) capabilities, the computing system 100 provides for protected execution of the algorithm(s). Using the above-described security features of the operating system 190 and platform 100, execution of the A3, A8 and A5 algorithms is substantially protected from software attacks and from unauthorized attempts to access associated data.

For another aspect, an application programming interface (API) for accessing SIM features on an open platform, such as the computing system 100, is provided. The SIM API is used by trusted applications to access SIM capabilities. The capabilities accessed through the SIM API may include one or more of the following or more: generation of authentication keys for use in the AAA mechanism (e.g. EAP, AKA); generation of encryption keys for encryption of data communications; access to user secrets such as subscription account information, contact names, addresses or phone/email; access to security policies; access to protected storage provided under a SIM file structure hierarchy; access to pre-configured SIM-based applications or utilities provisioned by a service provider (e.g. location updates, friend finder, etc.)

It will be appreciated that the API of various embodiments may provide for accessing additional and/or different SIM capabilities.

Thus, various embodiments of a method and apparatus for managing privacy and disclosure of computing system location information are described. In the foregoing specification, the invention has been described with reference to specific exemplary embodiments thereof. It will, however, be appreciated that various modifications and changes may be made thereto without departing from the broader spirit and scope of the invention as set forth in the appended claims. For example, while the exemplary embodiments described above refer to the use of SIM capabilities in association with wireless network use and/or access, the claimed SIM capabilities may be used in conjunction with other types of applications including, for example, wired network access, AAA capabilities for applications, etc. The specification and drawings are, accordingly, to be regarded in an illustrative rather than a restrictive sense.

1. A method comprising:
establishing a protected communications channel with a computing system, the computing system providing SIM AAA capabilities without the use of a discrete hardware SIM device; and
provisioning SIM secret data to the computing system over the protected communications channel.

2. The method of claim 1 wherein provisioning SIM secret data includes provisioning at least one of identity secrets, key secrets, information to initialize data objects, information to initialize operator-specific cryptography algorithms, and information to install or update applications, parameters, tools or utilities.

3. The method of claim 1 wherein establishing a protected communications channel includes using a protected key exchange mechanism.

4. The method of claim 3 wherein provisioning SIM secret data includes encrypting the SIM secret data.

5. A method comprising:
using SIM capabilities provided by a computing system without a discrete hardware SIM device for user authorization, authentication and accounting in association with a subscription account; and
providing a subscription account for access by the computing system.

6. The method of claim 5 wherein providing the subscription account includes providing a wireless network access account.

7. The method of claim 6 wherein using SIM capabilities provided by a computing system includes using SIM capabilities provided by a laptop computing system.

8. The method of claim 5 wherein providing the subscription account includes providing a wired network access account.

9. The method of claim 5 wherein using SIM capabilities includes using a protected execution environment provided by a laptop computing system.

10. The method of claim 5 wherein providing the subscription account includes providing location-based services.

11. A computer-accessible medium storing information, that when accessed by a computing system causes the computing system to:
establish a protected communications channel with a computing system, the computing system to provide SIM AAA capabilities without the use of a discrete hardware SIM device; and
provision SIM secret data to the computing system over the protected communications channel.

12. The computer-accessible medium of claim 11 wherein provisioning SIM secret data includes provisioning at least one of identity secrets, key secrets, information to initialize data objects, information to initialize operator-specific cryptography algorithms, and information to install or update applications, parameters, tools or utilities.

13. The computer-accessible storage medium of claim 12 wherein provisioning includes encrypting the secret data prior to providing the secret data to the computing system.

14. The computer-accessible storage medium of claim 11 wherein establishing a protected communications channel includes participating in a bilateral key exchange.

15. The computer-accessible storage medium of claim 14 wherein establishing a protected communications channel includes receiving authentication information from the computing system.

16. A method comprising:
authenticating and authorizing a user of a subscription account at least in part by using Subscriber Identity Module (SIM) compliant authentication and authorization capabilities on a computing system that provides the SIM-compliant authentication and authorization capabilities without the use of a discrete SIM hardware device; and
providing user access to the subscription account upon receipt of predetermined credentials.

17. The method of claim 16 wherein providing user access to the subscription account includes providing user access to a wireless network account.

18. The method of claim 17 wherein providing user access to wireless network account includes providing access to one of a GSM/GPRS network, a 3G network and a Personal Handyphone Network.

19. The method of 16 wherein providing user access to the subscription account includes providing user access to a location-based services account.

20. An apparatus comprising:
a server having access to a network; and
a provisioning module stored on the server, the provisioning module, when executed by the provisioning server, to participate in provisioning Subscriber Identity Module (SIM) secret data to a computing system, the computing system to provide SIM-compliant authentication, authorization and accounting capabilities without the use of a discrete hardware SIM device.

21. The apparatus of claim 20 wherein the network is one of a GSM/GPRS, 3G, Personal Handyphone System (PHS) and a CDMA network.

22. The apparatus of claim 20 wherein the network is a wireless network.

23. The apparatus of claim 20 wherein the network is a wired network.

24. The apparatus of claim 20 wherein the provisioning module, when executed by the server, further operates to encrypt the SIM secret data to be provided to the computing system.

25. The apparatus of claim 24 wherein the provisioning module, when executed by the server, further operates to participate in a bilateral key exchange with the computing system over the network.

26. The apparatus of claim 20 wherein the computing system is further to store the SIM secret data in an encrypted format on a mass storage device of the computing system.

27. The apparatus of claim 26 wherein the computing system is further to store an encrypted bulk encryption key to be used to decrypt the encrypted SIM secret data.

28. The apparatus of claim 27 wherein the computing system further includes a hardware token to provide a second key to encrypt the bulk encryption key.

29. The apparatus of claim 20 wherein the server is further to control access by the computing system to a service, the server to provide access to the service by the computing system upon authorization and authentication of the computing system using the SIM-compliant authentication, authorization and accounting capabilities.
